(19) United States
(12) Patent Application Publication
(10) Pub. No.: US 2026/0192537 A1
(43) Pub. Date: Jul. 9, 2026

(54) COMPRESSION-MOLDING MACHINE

(71) Applicant: Kikusui Seisakusho Ltd., Kyoto-shi (JP)

(72) Inventors: Yasushi FUJII, Kyoto-shi (JP); Kouichi ATAGI, Kyoto-shi (JP)

(21) Appl. No.: 19/423,765

(22) Filed: Dec. 17, 2025

(30) Foreign Application Priority Data
Jan. 8, 2025 (JP) 2025-002997

(51) Int. Cl. B30B 15/30; B30B 11/08

(52) U.S. Cl. CPC B30B 15/302; B30B 11/08

(57) ABSTRACT

A bottom plate of a housing of a feeder for filling die bores provided in a die table of a turret with a powdery material has a through-window through which the powdery material spread in a rotation direction of moving the die bores is dropped. Then, a sealant extending in the rotation direction is attached to a lower surface of the bottom plate at a position shifted inward and outward from the through-window along a radial direction orthogonal to the rotation direction. Further, a leveling plate extending in the radial direction is attached to the lower surface of the bottom plate at a position in the vicinity of the terminal end of the through-window along the rotation direction. A terminal end portion of the sealant is supported by a backing plate and the leveling plate.

### BACKGROUND

There has been known a rotary compression-molding machine including a turret including a die table including an outer circumferential portion including a large number of die bores, respectively, and an upper punch and a lower punch slidably retained above and below each of the die bores, respectively, and configured to horizontally rotate the die bores and the punches together and fill each of the die bores with a powdery material when the die bore passes just below a powdery-material filling device to compression-mold or tablet the powdery material in the die bore when the paired upper and lower punches pass between an upper roll and a lower roll.

The filling device mounted in the molding machine is typically configured as an agitated feeder incorporating a rotatable agitating rotor and configured to inject a powdery material into a die bore while agitating the powdery material. A bottom plate of the feeder is provided with a through-window (i.e., powdery-material feeding port for the die bore) extending along the rotation direction of the die table and the die bore. The powdery material in the feeder is dropped into the die bore of the die table through the through-window. A leveling plate and a sealant are attached to the lower surface side of the bottom plate facing the upper surface of the die table. The leveling plate is positioned in the vicinity of the terminal end of the through-window, and levels-off the excess of the powdery material filled in the die bore from the feeder. The sealant is at a position shifted inward and outward along a radial direction orthogonal to the rotation direction when viewed from the through-window, and reduces diffusion of the powdery material to a portion of the die table other than the die bore (e.g., see, for example, JP-A-2013-027917).

When the sealant is not appropriately attached to the bottom plate of the feeder (e.g., including a state in which the sealant partially undulates), or when the sealant is dragged and distorted by the die table during the operation of the molding machine to generate a gap between the sealant and the upper surface of the die table, the powdery material leaks to the outside of the feeder through the gap. The leaked powdery material may contaminate a portion on the die table and therefore the inside of the molding machine over a wide area. The powdery material as a raw material of the molded product often contains a substance harmful to a human body. For example, in a case where a double-layer tablet or a multi-layer tablet is produced, two or more feeders may be disposed in the molding machine, and the material forming each layer may be filled in the die bore from each feeder. However, if the powdery material including powdery material leaked from any of the feeders unexpectedly enters the die bore, the amounts or ratios of the components of the molded product may change, adversely affecting the quality of the molded product.

For this reason, it is necessary to avoid the powdery material leakage to the outside of the feeder as much as possible. Needless to say, the feeder of the existing molding machine is also designed such that the sealant is reliably retained on the bottom plate and no gap is generated between the sealant and the upper surface of the die table. However, the structure for assembling the sealant to the bottom plate is complicated, and the number of components is likely to be large.

### SUMMARY OF THE INVENTION

The exemplary invention is intended to appropriately prevent, with a simple configuration, a powdery material from unexpectedly leaking to the outside from a powdery-material filling feeder mounted on a rotary compression-molding machine.

In the exemplary invention, a rotary compression-molding machine is configured, which includes die bores penetrating a die table of a turret, and an upper punch and a lower punch slidably retained above and below each of the die bores and in which the compression-molding machine is configured such that the turret is horizontally rotated to fill the die bores with a powdery material from a feeder when the die bores pass below the feeder, and the powdery material filled in the die bores is compressed when the pair of the upper punch and the lower punch passes between an upper roll and a lower roll to mold and produce a molded product.

The feeder includes a housing holding the powdery material to be filled in the die bores and including, in a bottom plate facing the upper surface of the die table, a through-window through which the powdery material spread in a rotation direction of moving the die bores is dropped, a sealant protruding downward from the lower surface of the bottom plate and extending in the rotation direction at a position shifted inward and outward from the through-window along a radial direction orthogonal to the rotation direction on the lower surface of the bottom plate, and a leveling plate positioned at a position in the vicinity of the terminal end of the through-window along the rotation direction on the lower surface of the bottom plate, protruding downward from the lower surface of the bottom plate, extending in the radial direction, and supporting a terminal end portion of the sealant between the leveling plate and the bottom plate.

A powdery material is an aggregate of minute solids and conceptually includes an aggregate of particles such as so-called “granules” and an aggregate of powder smaller than such particles. A mixture of a plurality of powdery materials also corresponds to powdery materials. When a molded product is a tablet of a pharmaceutical product, its raw materials such as a cardinal remedy (i.e., principal agent), an excipient, and a lubricant are powdery materials, and the cardinal remedy mixed with a powdery material other than the cardinal remedy also corresponds to powdery materials.

With the above configuration, in the rotary compression-molding machine, it is possible to appropriately prevent the powdery material from unexpectedly leaking from between the feeder and the die table. Since the structure is employed, in which the terminal end portion of the sealant is supported by the bottom plate and leveling plate of the feeder, the structure for assembling the sealant is simplified, and the number of components is also reduced.

For example, the sealant has a base contacting or positioned close (e.g., adjacent) to the upper surface of the die table, and a supported piece extending from the terminal end of the base along the rotation direction and formed thinner in vertical dimension than the base, and the supported piece is supported by the bottom plate and the leveling plate. Since the terminal end of the base of the sealant contacts the leveling plate along the rotation direction, the leveling plate reduces displacement of the sealant even when the sealant is dragged by the rotating die table, and the leakage of the powdery material to the outside of the feeder is prevented.

With a structure in which a recessed groove recessed upward and extending in the rotation direction is formed in the lower surface of the bottom plate at a position shifted inward and outward from the through-window and the sealant is fitted into the recessed groove, the sealant can be more reliably attached to the bottom plate of the feeder.

If an elastic body configured to press the sealant toward the upper surface of the die table is embedded between the recessed groove in the lower surface of the bottom plate and the sealant, then the sealant can be reliably brought into contact with the upper surface of the rotating die table, and the powdery material does not leak to the outside of the feeder.

If a backing plate protruding downward from the lower surface of the bottom plate, extending in the radial direction at a position in the vicinity of the start end of the through-window along the rotation direction, and supporting a start end portion of the sealant between the backing plate and the bottom plate is provided, then the structure for assembling the sealant is simple even on the start end side of the sealant, and the number of components is reduced. The backing plate itself also contributes to reduction in the leakage of the powdery material to the outside of the feeder.

According to the exemplary invention, the unexpected leakage of the powdery material to the outside from the powdery-material filling feeder mounted on the rotary compression-molding machine can be appropriately prevented with the simple configuration.

### BRIEF DESCRIPTION OF THE DRAWINGS

The exemplary aspects of the invention will be better understood from the following detailed description of the exemplary embodiments of the invention with reference to the drawings in which:

FIG. 1 is a side sectional view of a rotary compression-molding machine according to an exemplary embodiment of the exemplary invention;

FIG. 2 is a plan view of a turret of the molding machine according to the exemplary embodiment;

FIG. 3 is a developed view showing the flow of a process of molding a molded product by the molding machine according to the exemplary embodiment and vertical motion of punches along with rotation of the turret;

FIG. 4 is a plan view of a feeder mounted in the molding machine according to the exemplary embodiment;

FIG. 5 is a sectional view taken along line 5-5 in FIG. 4, which shows the feeder according to the exemplary embodiment;

FIG. 6 is a bottom view showing the feeder according to the exemplary embodiment;

FIG. 7 is a perspective view showing, from below, a bottom plate of the feeder according to the exemplary embodiment;

FIG. 8 is an exploded perspective view showing, from below, a bottom plate member, a backing plate, a leveling plate, an elastic body, and a sealant of the feeder according to the exemplary embodiment;

FIG. 9 is an exploded perspective view showing, from above, the backing plate, the leveling plate, the elastic body, and the sealant of the feeder according to the exemplary embodiment; and

FIG. 10 is an enlarged sectional view taken along line 10-10 in FIG. 4, which shows a region including a terminal end portion of the sealant in the feeder according to the exemplary embodiment.

### DETAILED DESCRIPTION OF AN EXEMPLARY EMBODIMENT

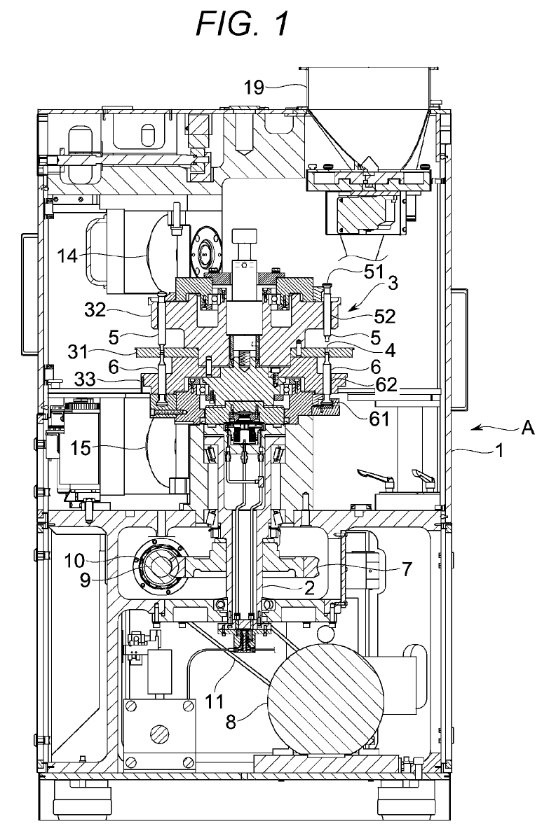

An exemplary embodiment of the invention will now be described with reference to the drawings. Initially described is an overview of an entire rotary compression-molding machine (hereinafter, referred to as a “molding machine”) A according to the exemplary embodiment, which is used in production of a molded product. As shown exemplarily in FIG. 1, the molding machine A includes a frame 1 accommodating an upright shaft 2 functioning as a rotary shaft and a turret 3 attached to an upper portion of the upright shaft 2.

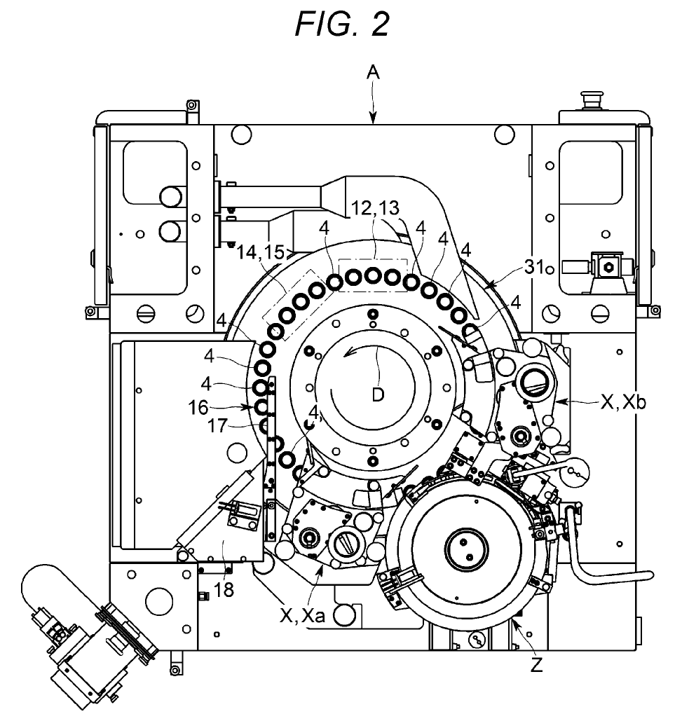

The turret 3 horizontally rotates about the upright shaft 2, and more specifically, spins thereabout. The turret 3 includes a die table (e.g., a die disc) 31, an upper punch-retaining portion 32, and a lower punch-retaining portion 33. As shown exemplarily in FIG. 2, the die table 31 has a substantially circular disc shape, and has a plurality of die bores 4 provided at predetermined intervals in an outer circumferential portion along a rotation direction D. Here, the die table 31 (and the turret 3 including a punch holding portion 32, and punches 5, 6) rotates counterclockwise in a plan view as indicated by an arrow D in the figure. The die bores 4 vertically penetrate the die table 31. The die table 31 may alternatively be divided into a plurality of plates. Instead of the die bores 4 formed by directly drilling into the die table 31 itself, the die table 31 may alternatively have a plurality of die members separated from the die table 31 and detachably attached to the die table 31. In this case, each of the die members has a die bore penetrating vertically.

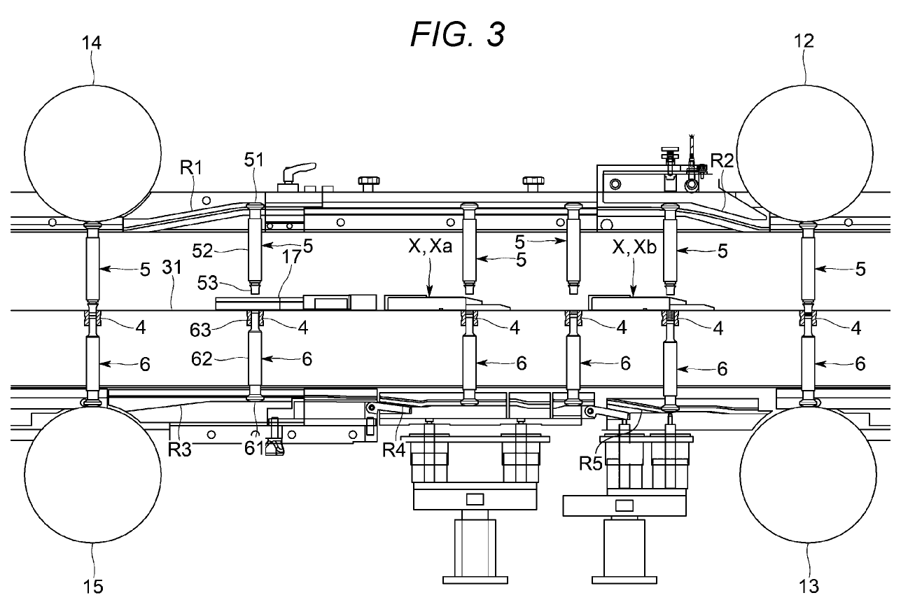

As shown exemplarily in FIGS. 1 and 3, each die bore 4 has an upper punch 5 and a lower punch 6 respectively disposed above and below the die bore 4. As shown exemplarily in FIG. 3, the upper punch 5 and the lower punch 6 are retained respectively by the upper punch-retaining portion 32 and the lower punch-retaining portion 33 so as to be independently slidable vertically with respect to a corresponding one of the die bores 4. The upper punch 5 has a punch tip 53 which enters and exits the corresponding one of the die bores 4. The lower punch 6 has a punch tip 63 kept inserted in the corresponding one of the die bores 4. The upper punch 5 and the lower punch 6 horizontally rotate, more specifically revolve, about the upright shaft 2 along with the turret 3 and the corresponding one of the die bores 4.

The upright shaft 2 has a lower end to which a worm wheel 7 is attached. The worm wheel 7 meshes with a worm gear 10. The worm gear 10 is fixed to a gear shaft 9 to be driven by a motor 8. Drive power outputted from the motor 8 is transmitted to the gear shaft 9 through a belt 11, so as to drive and to rotate the turret 3 and the punches 5, 6 coupled to the upright shaft 2 through the worm gear 10 and the worm wheel 7.

A powdery material as a material for a compression-molded product such as a tablet of a pharmaceutical product is injected from a powdery-material feeding device (not shown) to a hopper (or a buffer tank) 19, and is fed from the hopper 19 to a feeder X (Xa and Xb) (e.g., see FIGS. 2 and 3). The powdery material refilled to the molding machine A by the powdery-material feeding device may be a mixture of a plurality of types of powdery materials. In a case where the molded product to be produced is a tablet of a pharmaceutical product, it is a powdery material obtained by mixing a cardinal remedy (i.e., principal agent), an excipient such as lactose, crystalline cellulose, or starch, and a lubricant such as magnesium stearate or talc.

The powdery material is filled into the die bores 4 of the die table 31 from the feeder X. The feeder X (Xa and Xb) (e.g., see FIG. 2) as a filling device is positioned on the outer circumferential portion of the rotating die table 31, particularly, just above rotational orbits of the die bores 4. The die table 31 rotating along with the turret 3 causes the die bores 4 to be displaced relatively to the feeder X. As shown exemplarily in FIGS. 2 and 3, a plurality of feeders Xa and Xb can be disposed in one molding machine A.

As shown exemplarily in FIGS. 2 and 3, a preliminary compression upper roll 12, a preliminary compression lower roll 13, a substantial compression upper roll 14, and a substantial compression lower roll 15 are present on revolution orbits of the punches 5 and 6 about the upright shaft 2. The preliminary compression upper roll 12 and the preliminary compression lower roll 13 are paired to vertically sandwich the punches 5 and 6, and the substantial compression upper roll 14 and the substantial compression lower roll 15 are paired to vertically sandwich the punches 5 and 6. The preliminary compression upper roll 12 and the preliminary compression lower roll 13 as well as the substantial compression upper roll 14 and the substantial compression lower roll 15 bias both upper and lower punches 5 and 6, respectively, to bring the upper and lower punches 5 and 6 closer to each other, so that the tip end surfaces of the punch tips 53, 63 respectively compress from above and below the powdery material filled in the die bores 4.

The upper and lower punches 5 and 6 have heads 51 and 61, respectively, pressed by the rolls 12, 13, 14 and 15, and trunks 52 and 62 which are smaller respectively in diameter than the heads 51 and 61. The upper punch-retaining portion 32 (e.g., shown in FIG. 1) of the turret 3 vertically slidably retains the trunks 52 of the upper punches 5, whereas the lower punch-retaining portion 33 vertically slidably retains the trunks 62 of the lower punches 6. Tip end portions 53 and 63 of the trunks 52 and 62 are thinner than other portions and have diameters substantially equal to the inner diameter of the die bores 4 so as to be inserted into the die bores 4. The punches 5 and 6 revolve to bring the rolls 12, 13, 14 and 15 closer to the heads 51 and 61 of the punches 5 and 6, respectively. The rolls 12, 13, 14 and 15 come into contact with the heads 51 and 61 to step thereonto. The rolls 12, 13, 14 and 15 further press the upper punches 5 downward and press the lower punches 6 upward. While the rolls 12, 13, 14 and 15 are in contact with flat surfaces of the punches 5 and 6, the punches 5 and 6 keep applying a constant pressure to the powdery material in the corresponding die bores 4.

There is a collecting position for a completed molded product, in a downstream portion ahead, in the rotation direction D of the turret 3 and the punches 5 and 6, of a position pressed by the substantial compression upper roll 14 and the substantial compression lower roll 15. The collecting position has a guide member (or a scraper) 17.

Vertical motion of the upper and lower punches 5, 6 is caused by cam rails R1, R2, R3, R4 and R5. The rails R1, R2, R3, R4 and R5 extend in the rotation direction D of the turret 3 and the punches 5 and 6, and are engaged with the heads 51 and 61 of the punches 5 and 6, respectively, to guide and vertically move the punches 5 and 6.

As shown exemplarily in FIG. 3, the head 51 of each of the upper punches 5 has a rotational orbit including the ascending rail (i.e., ascending cam) R1 configured to lift the upper punch 5 upward at a position upstream of the guide member 17 and extract the punch tip 53 from the die bore 4, and the descending rail (i.e., descending cam) R2 configured to push the upper punch 5 downward at a position upstream of the rolls 12, 14 and insert the punch tip 53 into the die bore 4 to be ready for later compression of the powdery material.

The rotational orbit of the head 61 of each of the lower punches 6 has the push-up rail R3 configured to lift the lower punch 6 upward at a position upstream of the guide member 17 and brings the punch tip 63 to a height substantially equal to that of the upper surface of the die table 31, the reducer R4 configured to lower the lower punch 6 downward at a position upstream or in the vicinity of the first feeder Xa and bring the volume of the die bore 4 on the punch tip 63 to a size corresponding to the amount of the powdery material to be filled in the die bore 4 from the feeder Xa, and the reducer R5 configured to further lower the lower punch 6 downward at a position upstream or in the vicinity of the second feeder Xb and bring the volume of the die bore 4 on the punch tip 63 to a size corresponding to the amount of the powdery material to be filled in the die bore 4 from the feeder Xb. The second half of the reducer rail R5 has a shape obtained by slightly lowering the lower punch 6 such that the powdery material in the die bore 4 after the amount of the powdery material is adjusted does not spill out of the die bore 4 due to a centripetal force or the like.

An example of a molded product production process will be described. As shown exemplarily in FIG. 3, the lower punch 6 including the punch tip 63 inserted into the die bore 4 initially descends to increase the internal volume of the die bore 4 to a required size. When the die bore 4 passes just below the first feeder Xa, the feeder Xa pours the powdery material into the die bore 4. Before the feeder Xa fills the die bore 4 with the powdery material, a spray device (not shown) that sprays a lubricant may spray and apply the lubricant to the inner circumferential surface of the die bore 4, the upper surface of the punch tip 63 of the lower punch 6 inserted into the die bore 4, and the lower surface of the punch tip 53 of the upper punch 5 above the die bore 4.

Subsequently, the lower punch 6 further descends to increase the internal volume of the die bore 4 to a required size, and the feeder Xb pours the powdery material into the die bore 4 when the die bore 4 passes just below the second feeder Xb. This forms a two-layer structure including the powdery material filled from the first feeder Xa as a lower layer and the powdery material filled from the second feeder Xb as an upper layer in the die bore 4. The powdery material as the lower layer and the powdery material as the upper layer may be different in type, composition, contained component, or the like, or may be the same.

As shown exemplarily in FIG. 2, a core injection device may be disposed at a position between the first feeder Xa and the second feeder Xb along the rotation direction D of the die table 31 and the die bores 4. The core injection device is used for molding a dry-coated molded product (i.e., dry-coated tablet including a core tablet, other inner cores, a semiconductor integrated circuit chip (may be referred to as an electronic device, an IC tag, or an RFID tag), or the like in a layer formed of a raw powdery material) in the molding machine A. In this case, when the die bore 4 previously filled with the powdery material by the first feeder Xa passes the vicinity of the core injection device, the core injection device injects the core into the die bore 4. When the die bore 4 reaches the vicinity of the second feeder Xb, the die bore 4 is filled with an additional powdery material from the second feeder Xb to cover the core.

However, the core injection device is not an essential constituent element. The number of feeders Xa and Xb mounted on the molding machine A is not limited, and may be one or three or more.

After the feeder X (Xa and Xb) fills the die bore 4 with the powdery material, the upper punch 5 then descends, and the preliminary compression upper roll 12 and the preliminary compression lower roll 13 press, respectively, the head 51 of the upper punch 5 and the head 61 of the lower punch 6 such that the punch tips 53 and 63 of both these punches 5 and 6, respectively, preliminarily compress the powdery material in the die bore 4, as shown exemplarily in FIG. 3. The substantial compression upper roll 14 and the substantial compression lower roll 15 subsequently press, respectively, the head 51 of the upper punch 5 and the head 61 of the lower punch 6 such that the punch tips 53 and 63 of both these punches 5, 6, respectively, substantially compress the powdery material in the die bore 4.

The lower punch 6 eventually ascends until the upper end surface of the punch tip 63 of the lower punch 6 ascends to be substantially as high as the upper end of the die bore 4 (i.e., the upper surface of the die table 31) and pushes the molded product out of the die bore 4 onto the die table 31. The molded product ejected from the die bore 4 is brought into contact with and is scraped by the guide member 17 in a product unloading portion 16 due to rotation of the turret 3, and moves along the guide member 17 toward a molded product chute 18.

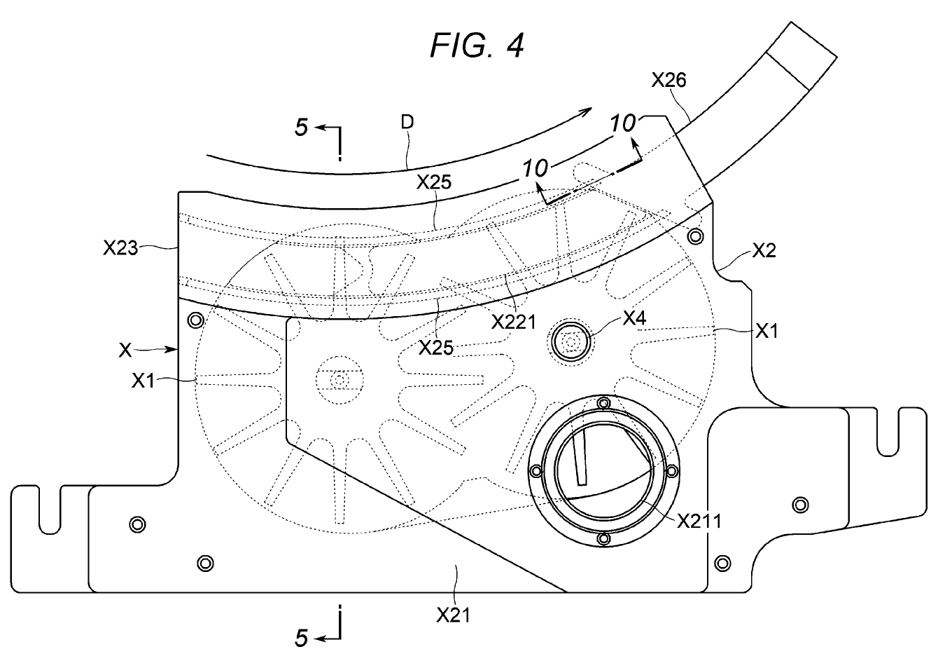

Hereinafter, each feeder X (Xa and Xb) will be supplementarily described. The feeder X according to the exemplary embodiment is an agitated feeder configured to drop, into the die bores 4, the powdery material being agitated by rotating an incorporated agitating rotor X1. As shown exemplarily in FIGS. 4 to 6, the feeder X includes, as principal constituent elements, a housing X2 configured to receive the powdery material fed from a powdery material mixing and feeding device, a single or a plurality of agitating rotors X1 configured to rotate in the housing X2 to agitate the powdery material as well as drop the powdery material from the housing X2 into the die bores 4 of the die table 31, at least one motor (not shown) configured to output drive power to rotate the agitating rotors X1, and a transmission mechanism X3 configured to transmit rotation of an output shaft X4 of the motor to shafts of the agitating rotors X1.

The housing X2 is obtained by fixing a bottom plate member X22 below a housing body X21 to have a flat box shape containing an internal space. The housing body X21 has an upper surface including a powdery material supply port X211 configured to guide the powdery material into the housing X2. The powdery material supply port X211 is connected to the hopper 19 of the molding machine A, and the powdery material is fed from the powdery material mixing and feeding device to the feeder X through the hopper 19.

The bottom plate member X22 forms a bottom plate of the housing X2, and has a flat dish shape mostly closing from below the internal space of the housing body X21. The bottom plate member X22 includes a window X221 including a substantially arc shape in a plan view and vertically penetrating the bottom plate member X22. The through-window X221 functions as a drop port (i.e., port for feeding the powdery material to the die bores 4) configured to drop the powdery material to be filled in the die bores 4 of the die table 31 in the molding machine A from inside the housing X2 toward the die bores 4, and extends along the rotation direction D of the die table 31 and the die bores 4 so as to overlap in a plan view with a passage through which the die bores 4 pass when the feeder X is disposed at a required position in the molding machine A.

Each of the agitating rotors X1 is a member comprising a hub functioning as a central shaft and a plurality of wings (e.g., blades) extending radially from the hub in a plan view, is accommodated in the internal space of the housing X2, and agitates with use of the wings the powdery material in the housing X2. The feeder X of the shown example includes a pair of agitating rotors X1, each of which horizontally rotates about a vertical axis with the hub as the center of rotation.

The transmission mechanism X3 is a gearbox including a plurality of gears meshing with each other. The output shaft X4 of the motor is fixed to one of these gears, as well as the hub as the shaft of one of the agitating rotors X1 is fixed to any one of the gears and the hub as the shaft of the other agitating rotor X1 is fixed to any other one of the gears, to transmit the drive power outputted from the single motor to both the agitating rotors X1. The transmission mechanism X3 includes a gear train positioned just above the agitating rotors X1 in the housing X2. The motor is disposed above the housing X2, and the output shaft X4 extending downward penetrates a shaft hole drilled in the upper surface of the housing X2 and enters the housing X2 to be connected to the gear.

Examples of the motor include a servo motor configured to appropriately control the rotational speed thereof, and a control device is capable of acquiring the magnitude of a load torque currently acting on the motor and the magnitude of an applied current. Each of the agitating rotors X1 has a rotational speed determined in accordance with the rotational speed of the motor and the change gear ratio of the gear train included in the transmission mechanism X3. Adjusting the number of teeth of each of the gears in the gear train included in the transmission mechanism X3 enables an appropriate change in a ratio between the rotational speed of one of the agitating rotors X1 and the rotational speed of the other agitating rotor X1. Adjusting the number of gears interposed between the motor and each of the agitating rotors X1 also enables an appropriate change in the rotation direction of each of the agitating rotors X1. Specifically, one of the agitating rotors X1 can rotate in a direction opposite to the rotation direction of the other agitating rotor X1, or both the agitating rotors X1 can rotate in an identical direction.

The number of motors configured to drive to rotate the agitating rotors X1 is not limited to be less than the number of agitating rotors X1. There may be provided motors identical in the number of agitating rotors X1. If the same number of motors as that of the plurality of agitating rotors X1 is used, the output shaft of each motor is connected to the hub as the shaft of each of the agitating rotors X1, and each of the agitating rotors X1 is individually rotationally driven by each motor, the rotational speed and rotation direction of each of the agitating rotors X1 can be individually changed through the control of the rotational speed and rotation direction of each motor. The number of agitating rotors X1 in the feeder X is not limited to two, and may be three or more.

The powdery material fed from the hopper 19 to the feeder X drops from the through-window X221 of the bottom plate X22 of the housing X2 toward the die table 31 of the molding machine A while being agitated by the agitating rotors X1 in the housing X2, and is filled in the die bores 4. However, not all of the powdery material including dropped from the through-window X221 is necessarily filled in the die bores 4, and there is a possibility that an excess powdery material leaks to the outside from between the feeder X and the die table 31. In order to reduce such leakage of the powdery material, a sealant X25, a leveling plate X26, and a backing plate X23 are attached to the lower surface side of the bottom plate X22 of the housing X2 facing the upper surface of the die table 31.

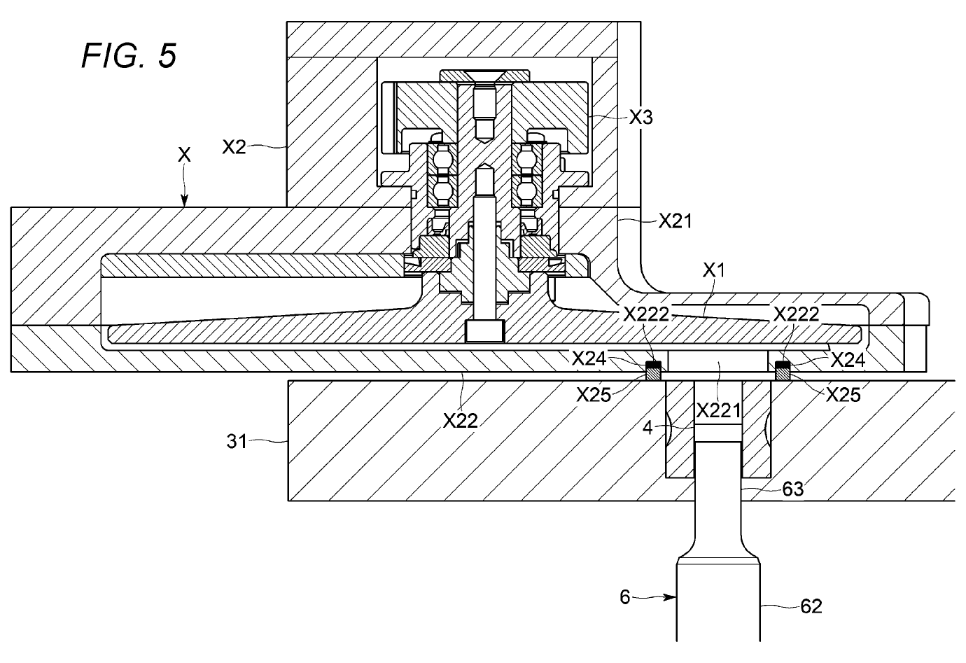

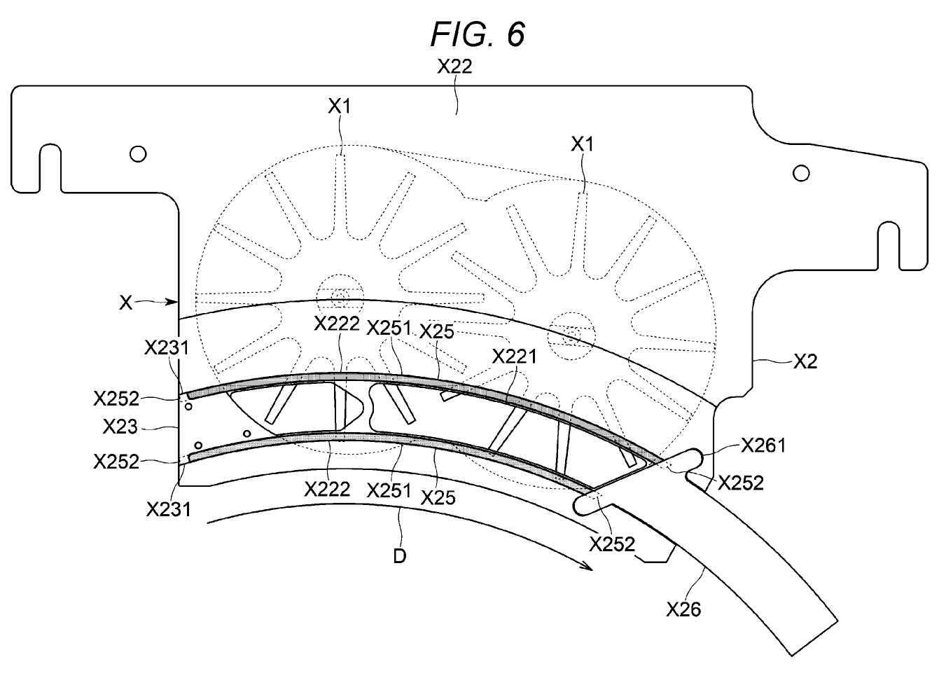

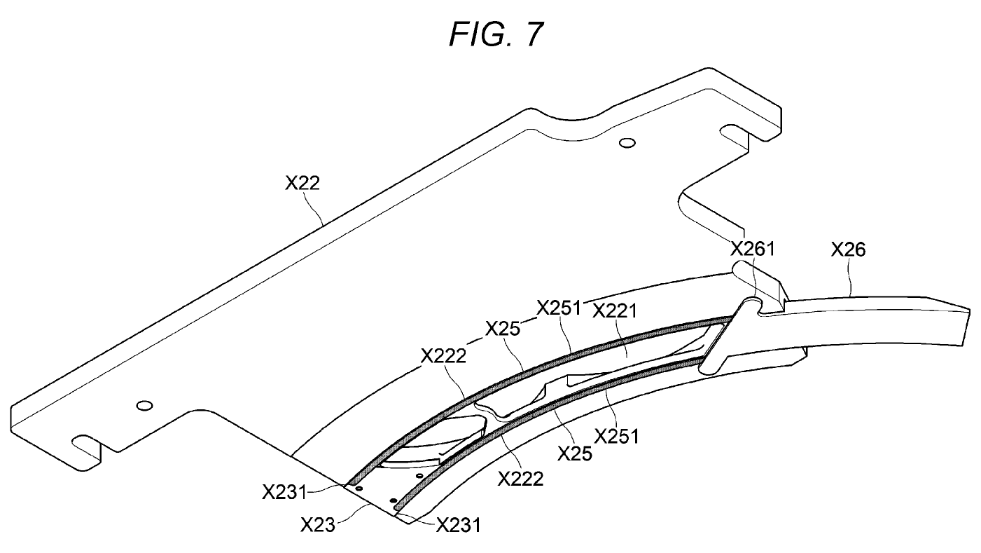

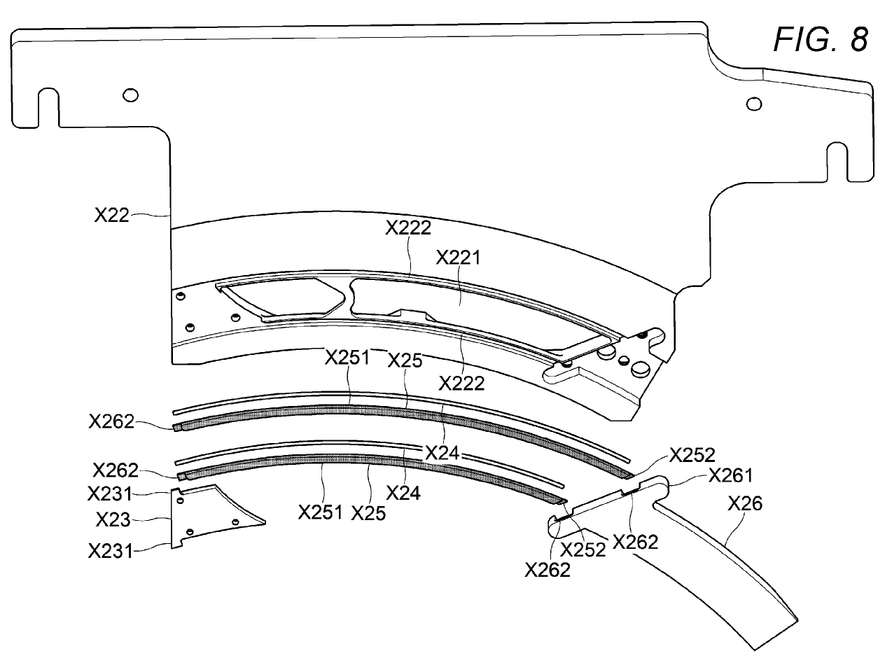

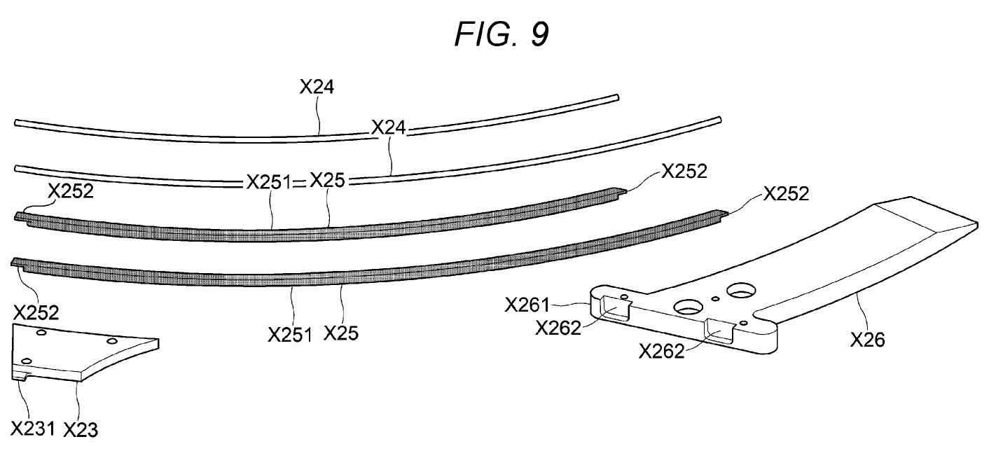

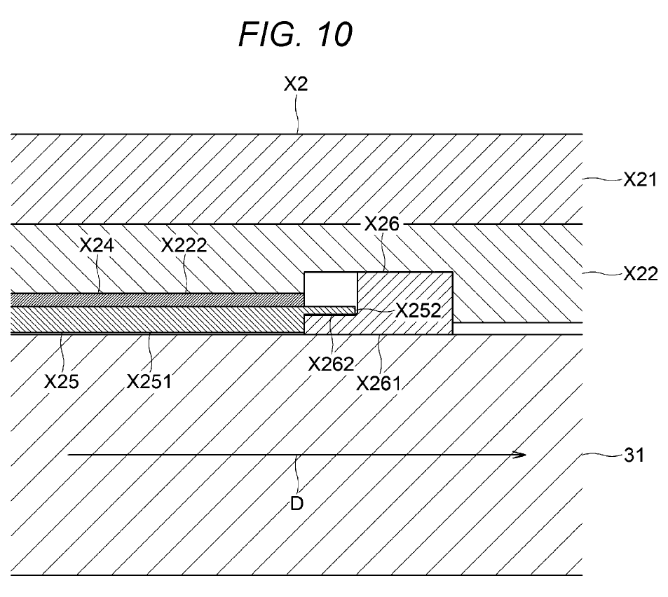

As shown exemplarily in FIGS. 6 to 10, the sealant X25 has a base X251 including a substantially arc linear shape in a plan view along the side edge of the through-window X221, and supported pieces X252 extending from upper edge portions of the base X251 at the start end and terminal end thereof. The vertical dimension of the supported pieces X252 is thinner than the vertical dimension of the base X251. The base X251 and supported pieces X252 of the sealant X25 extend along the rotation direction D of the die table 31 and the die bores 4. There is a pair of sealants X25, and these sealants X25 are disposed in parallel inside and outside the through-window X221 (i.e., along a radial direction orthogonal to the rotation direction D) on the lower surface of the bottom plate X22. As shown exemplarily in FIGS. 5 and 10, the sealant X25 protrudes downward from the lower surface of the bottom plate X22, and seals a gap between the lower surface of the bottom plate X22 and the upper surface of the die table 31. The sealant X25 prevents the powdery material dropped through the through-window X221 from leaking to the outside of the feeder X and diffusing to a portion of the die table 31 other than the die bores 4.

Recessed grooves X222 recessed upward and extending along the rotation direction D of the die table 31 are formed in advance at positions shifted inward and outward from the through-window X221 on the lower surface of the bottom plate X22. Each of the sealants X25 is fitted into a corresponding one of the recessed grooves X222. At this time, as shown exemplarily in FIGS. 5 and 10, an elastic body X24 is embedded between the upper surface of the sealant X25 and the bottom surface of the recessed groove X222. The elastic body X24 is a linear or small-diameter tube including a substantially arc shape in a plan view, which is similar to that of the base of the sealant X25, and made of a soft resin such as rubber. The elastic body X24 is compressed by the sealant X25 to generate elastic force, and the elastic force presses the sealant X25 downward toward the die table 31 to bring the lower surface of the sealant X25 into close contact with the upper surface of the die table 31.

The leveling plate X26 is disposed on the lower surface of the bottom plate X22 in the vicinity of the terminal end of the through-window X221 in the rotation direction D of the die table 31. Of the leveling plate X26, an end portion X261 adjacent to the terminal end of the through-window X221 expands larger than the opening width along the radial direction of the through-window X221. The leveling plate X26 protrudes downward from the lower surface of the bottom plate X22, and seals the gap between the lower surface of the bottom plate X22 and the upper surface of the die table 31. The leveling plate X26 also prevents the powdery material dropped through the through-window X221 from leaking to the outside of the feeder X and diffusing to a portion of the die table 31 other than the die bores 4. In particular, the end portion X261 of the leveling plate X26 functions to level off the excess of the powdery material filled in the die bores 4 of the die table 31 from the feeder X as the die table 31 rotates.

In the upper surface of the end portion X261 of the leveling plate X26, a cutout X262 recessed downward is formed. The supported piece X252 at the terminal end portion of the sealant X25 is accommodated in the cutout X262. That is, the supported piece X252 is placed in the cutout X262. Then, the supported piece X252 of the sealant X25 is supported between the lower surface of the bottom plate X22 and the upper surface of the end portion X261 of the leveling plate X26.

When the die table 31 rotates, the sealant X25 is dragged by the die table 31. However, as shown exemplarily in FIG. 10, the terminal end of the base X251 of the sealant X25 abuts on and closely contacts the end portion X261 of the leveling plate X26 along the rotation direction D of the die table 31, whereby displacement of the sealant X25 is reduced.

The backing plate X23 is disposed on the lower surface of the bottom plate X22 in the vicinity of the start end of the through-window X221 in the rotation direction D of the die table 31. The backing plate X23 protrudes downward from the lower surface of the bottom plate X22, and seals the gap between the lower surface of the bottom plate X22 and the upper surface of the die table 31. The backing plate X23 also prevents the powdery material dropped through the through-window X221 from leaking to the outside of the feeder X and diffusing to a portion of the die table 31 other than the die bores 4.

Support pieces X231 extending laterally to both sides are formed at both side edges along the radial direction of the backing plate X23. The supported piece X252 at the start end portion of the sealant X25 is placed on the support piece X231. The supported piece X252 of the sealant X25 is supported between the lower surface of the bottom plate X22 and the upper surface of the support piece X231 of the backing plate X23.

Each of the leveling plate X26 and the backing plate X23 is fixed to the lower surface of the bottom plate X22 of the housing X2 using an appropriate fastener (not shown) such as a bolt or a screw. The leveling plate X26 and backing plate X23 are detachable from the bottom plate X22 of the housing X2. The sealant X25 and the elastic body X24 are also detachable from the bottom plate X22 of the housing X2. Any of the sealant X25, the elastic body X24, the leveling plate X26, and the backing plate X23 can be easily replaced when abrasion or the like occurs.

According to the exemplary embodiment, the sealant X25 can be easily attached to the bottom plate X22 of the housing X2 of the feeder X. Moreover, the number of components comprising the leveling plate X26 and the backing plate X23 can be reduced, and the structure is also simplified.

The sealant X25 is supported not only by the recessed groove X222 of the bottom plate X22 but also by the end portion of the leveling plate X26. Thus, even when the sealant X25 is dragged by the die table 31, it is possible to reliably reduce the leakage of the powdery material from the feeder X to the outside without distortion. Even when the feeder X is lifted upward so as to be separated from the upper surface of the die table 31, the sealant X25 does not drop from the feeder, and in this state, the sealant X25 can be easily replaced.

The exemplary invention is not limited to the exemplary embodiment detailed above. Specific configurations of the respective portions can be modified in various manners without departing from the spirit of the exemplary invention.

The descriptions of the various exemplary embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant’s intent is to encompass the equivalents of all claim elements, and no amendment to any claim of the present application should be construed as a disclaimer of any interest in or right to an equivalent of any element or feature of the amended claim.

What is claimed is:

1. A rotary compression-molding machine comprising:
a turret including a die table, the die table having die bores penetrating therethrough;
a feeder positioned adjacent the die table;
an upper punch and a lower punch slidably retained above and below, respectively, each of the die bores; and
an upper roll and a lower roll provided adjacent the upper punch and the lower punch, respectively, wherein the compression-molding machine is configured such that the turret is horizontally rotated to fill the die bores with a powdery material from the feeder when the die bores pass below the feeder, and the powdery material filled in the die bores is compressed when a pair of the upper punch and the lower punch passes between the upper roll and the lower roll, respectively, to mold and produce a molded product, and
the feeder includes
a housing holding the powdery material to be filled in the die bores and including, in a bottom plate facing an upper surface of the die table, a through-window through which the powdery material spread in a rotation direction of moving the die bores is dropped,
a sealant protruding downward from a lower surface of the bottom plate and extending in the rotation direction at a position shifted inward and outward from the through-window along a radial direction orthogonal to the rotation direction on the lower surface of the bottom plate, and
a leveling plate positioned at a position in a vicinity of a terminal end of the through-window along the rotation direction on the lower surface of the bottom plate, protruding downward from the lower surface of the bottom plate, extending in the radial direction, and supporting a terminal end portion of the sealant between the leveling plate and the bottom plate.

2. The compression-molding machine according to claim 1, wherein the sealant comprises a base contacting or positioned adjacent to the upper surface of the die table, and a supported piece extending from a terminal end of the base along the rotation direction and formed thinner in a vertical dimension than the base, and the supported piece is supported by the bottom plate and the leveling plate.

3. The compression-molding machine according to claim 2, wherein the terminal end of the base of the sealant contacts the leveling plate along the rotation direction.

4. The compression-molding machine according to claim 1, wherein a recessed groove recessed upward and extending in the rotation direction is formed in the lower surface of the bottom plate at a position shifted inward and outward from the through-window, and
the sealant is fitted into the recessed groove.

5. The compression-molding machine according to claim 4, wherein an elastic body configured to press the sealant toward the upper surface of the die table is embedded between the recessed groove in the lower surface of the bottom plate and the sealant.

6. The compression-molding machine according to claim 1, further comprising a backing plate protruding downward from the lower surface of the bottom plate, extending in the radial direction at a position in a vicinity of a start end of the through-window along the rotation direction, and supporting a start end portion of the sealant between the backing plate and the bottom plate.

7. The compression-molding machine according to claim 2, further comprising a backing plate protruding downward from the lower surface of the bottom plate, extending in the radial direction at a position in a vicinity of a start end of the through-window along the rotation direction, and supporting a start end portion of the sealant between the backing plate and the bottom plate.

8. The compression-molding machine according to claim 3, further comprising a backing plate protruding downward from the lower surface of the bottom plate, extending in the radial direction at a position in a vicinity of a start end of the through-window along the rotation direction, and supporting a start end portion of the sealant between the backing plate and the bottom plate.

9. The compression-molding machine according to claim 4, further comprising a backing plate protruding downward from the lower surface of the bottom plate, extending in the radial direction at a position in a vicinity of a start end of the through-window along the rotation direction, and supporting a start end portion of the sealant between the backing plate and the bottom plate.

10. The compression-molding machine according to claim 5, further comprising a backing plate protruding downward from the lower surface of the bottom plate, extending in the radial direction at a position in a vicinity of a start end of the through-window along the rotation direction, and supporting a start end portion of the sealant between the backing plate and the bottom plate.

11. The compression-molding machine according to claim 1, wherein the housing comprises an agitating rotor, and the powdery material from the feeder drops from the through-window of the bottom plate of the housing toward the die table while being agitated by the agitating rotor in the housing, and is filled in the die bores,
further comprising a backing plate, wherein the sealant, the leveling plate, and the backing plate are attached to the lower surface of the bottom plate of the housing facing the upper surface of the die table.

12. The compression-molding machine according to claim 1, wherein the sealant comprises a base including a substantially arc linear shape in a plan view along a side edge of the through-window, and supported pieces extending from upper edge portions of the base,
wherein a vertical dimension of the supported pieces is thinner than a vertical dimension of the base, and the base and supported pieces of the sealant extend along the rotation direction of the die table and the die bores, the sealant being a first sealant,
the compression-molding machine further comprising a second sealant such that the first and second sealants are disposed in parallel inside and outside the through-window on the lower surface of the bottom plate, and
wherein the first sealant seals a gap between the lower surface of the bottom plate and the upper surface of the die table, thereby to prevent the powdery material dropped through the through-window from leaking to an outside of the feeder and diffusing to a portion of the die table other than the die bores.

13. The compression-molding machine according to claim 1, wherein a groove recessed upward and extending along the rotation direction of the die table is formed at positions shifted inward and outward from the through-window on the lower surface of the bottom plate,
wherein the sealant is fitted into the recessed groove,
the compression-molding machine further comprising an elastic body embedded between an upper surface of the sealant and a bottom surface of the recessed groove, and
wherein the elastic body comprises a tube including a substantially arc shape in a plan view, and is compressed by the sealant to generate an elastic force, such that the elastic force presses the sealant downward toward the die table, thereby to bring a lower surface of the sealant into close contact with the upper surface of the die table.

14. The compression-molding machine according to claim 1, wherein the leveling plate includes an end portion adjacent to the terminal end of the through-window which expands larger than an opening width along the radial direction of the through-window, and seals a gap between the lower surface of the bottom plate and the upper surface of the die table, such that the leveling plate prevents the powdery material dropped through the through-window from leaking to an outside of the feeder and diffusing to a portion of the die table other than the die bores.

15. The compression-molding machine according to claim 1, wherein an end portion of the leveling plate levels-off an excess amount of the powdery material filled in the die bores of the die table from the feeder as the die table rotates,
wherein in an upper surface of the end portion of the leveling plate, a cutout recessed downward is formed, and a supported piece at the terminal end portion of the sealant is accommodated in the cutout, such that the supported piece of the sealant is supported between the lower surface of the bottom plate and the upper surface of the end portion of the leveling plate, the sealant being dragged by the die table as the die table rotates, and
wherein a terminal end of a base of the sealant abuts on the end portion of the leveling plate along the rotation direction of the die table.

16. The compression-molding machine according to claim 1, further comprising a backing plate disposed on the lower surface of the bottom plate in a vicinity of a start end of the through-window in the rotation direction of the die table,
wherein the backing plate protrudes downward from the lower surface of the bottom plate, and seals a gap between the lower surface of the bottom plate and the upper surface of the die table, thereby to prevent the powdery material dropped through the through-window from leaking to an outside of the feeder and diffusing to a portion of the die table other than the die bores.

17. The compression-molding machine according to claim 16, further comprising a support piece extending laterally and formed at both side edges along a radial direction of the backing plate,
wherein a supported piece at a start end portion of the sealant is placed on the support piece, and the supported piece of the sealant is supported between the lower surface of the bottom plate and an upper surface of the support piece of the backing plate,
wherein the leveling plate and backing plate are detachable from the bottom plate of the housing, and the sealant is detachable from the bottom plate of the housing, and
wherein the sealant is supported by the bottom plate and by an end portion of the leveling plate.

18. A feeder applied to a rotary compression-molding machine comprising a turret including a die table having die bores penetrating therethrough, a feeder positioned adjacent the die table, an upper punch and a lower punch slidably retained above and below each of the die bores, respectively, and an upper roll and a lower roll provided adjacent the upper punch and the lower punch, respectively, the compression-molding machine being configured such that the turret is horizontally rotated to fill the die bores with a powdery material from the feeder when the die bores pass below the feeder, and the powdery material filled in the die bores is compressed when a pair of the upper punch and the lower punch passes between the upper roll and the lower roll, respectively, to mold and produce a molded product, the feeder comprising:
a housing holding the powdery material to be filled in the die bores and including, in a bottom plate facing an upper surface of the die table, a through-window through which the powdery material spread in a rotation direction of moving the die bores is dropped;
a sealant protruding downward from a lower surface of the bottom plate and extending in the rotation direction at a position shifted inward and outward from the through-window along a radial direction orthogonal to the rotation direction on the lower surface of the bottom plate; and
a leveling plate positioned at a position in a vicinity of a terminal end of the through-window along the rotation direction on the lower surface of the bottom plate, protruding downward from the lower surface of the bottom plate, extending in the radial direction, and supporting a terminal end portion of the sealant between the leveling plate and the bottom plate.

19. A feeder according to claim 18, wherein the sealant has a base contacting or positioned adjacent to the upper surface of the die table, and a supported piece extending from a terminal end of the base along the rotation direction and formed thinner in a vertical dimension than the base, and the supported piece is supported by the bottom plate and the leveling plate.

20. A feeder applied to a rotary compression-molding machine comprising a turret including a die table having die bores penetrating therethrough, the compression-molding machine being configured such that the turret is horizontally rotated to fill the die bores with a powdery material from the feeder when the die bores pass below the feeder, the feeder comprising:
a housing holding the powdery material to be filled in the die bores and including, in a bottom plate facing an upper surface of the die table, a through-window through which the powdery material spread in a rotation direction of moving the die bores is dropped;
a sealant protruding downward from a lower surface of the bottom plate and extending in the rotation direction at a position shifted inward and outward from the through-window along a radial direction orthogonal to the rotation direction on the lower surface of the bottom plate; and
a leveling plate positioned at a position in a vicinity of a terminal end of the through-window along the rotation direction on the lower surface of the bottom plate, protruding downward from the lower surface of the bottom plate, extending in the radial direction, and supporting a terminal end portion of the sealant between the leveling plate and the bottom plate.
